(19) United States
(12) Patent Application Publication
(10) Pub. No.: US 2009/0070200 A1
(43) Pub. Date: Mar. 12, 2009

(54) ONLINE QUALITATIVE RESEARCH SYSTEM

(76) Inventor: Steven H. August, Portland, OR (US)

Correspondence Address: Intellectual Property Dept.;Dewitt Ross & Stevens SC, 2 East Mifflin Street, Suite 600, Madison, WI, 53703-2865, US

(21) Appl. No.: 12/278,174

(22) PCT Filed: Feb. 2, 2007
(86) PCT No.: PCT/US07/61555

§ 371 Date: Aug. 4, 2008

Related U.S. Application Data
(60) Provisional application No. 60/764,926, filed on Feb. 3, 2006.

(51) Int. Cl. G06Q 30/00

(52) U.S. Cl. 705/10

(57) ABSTRACT

An online research system delivers allows a researcher to script queries to be delivered to research participants, delivers the queries, collects research participant feedback, and aggregates the feedback for review and analysis by the researcher. Tools are provided which allow queries to be rapidly and easily scripted, and the researcher may situate the queries along a timeline to schedule their automatic delivery. Researchers may assign “tags” to feedback, wherein researchers may select content from feedback and apply a label, and thereafter rapidly access this content by referencing its label. As a result, researchers are able to rapidly catalogue useful content for use in compiling their findings regarding research participant feedback.

### CROSS-REFERENCE TO RELATED APPLICATIONS

This application claims priority under 35 USC §119(e) to U.S. Provisional Patent Application 60/764,926 filed 3 Feb. 2006, the entirety of which is incorporated by reference herein.

### FIELD OF THE INVENTION

This document concerns an invention relating generally to systems and methods for conducting online research (i.e., research using networked communications), and more specifically to systems and methods of this nature which are directed to qualitative market research of consumer behavior, experiences, thoughts, and perceptions.

### BACKGROUND OF THE INVENTION

Qualitative market research studies consumer behavior, experiences, thoughts, and perceptions and attempts to make these subjects meaningful in the context of a business question, i.e., how these subjects bear on a particular business particular topic, problem or opportunity. The findings of qualitative research ordinarily do not strive to be statistically representative of the whole population, but rather seek to describe the experiences of consumers in rich detail. Thus, qualitative market research usually focuses on the experiences of a relatively small representative set of consumers rather than on a large consumer sample set. There are a number of research methods used for qualitative market research, with probably the most well known methods involving the use of consumer focus groups. Another method is ethnography, wherein researchers will personally follow consumers and observe their behaviors.

For the most part, qualitative market research generates data in the form of open consumer responses in transcripts, images/video, and audio recordings. Because qualitative data is open-ended in that it is not chosen from a well-defined range or set, and/or readily processable by standard numeric/statistical approaches, it is sometimes referred to as unstructured data. However, quantitative data—structured data, with preset questions and responses, and which is readily processable by numeric or statistical methods—is sometimes collected as well. Such quantitative data may also take the form of numeric or discrete data representing measurements of consumer behavior, e.g., the number of mobile telephone calls a consumer makes in a day, or the brand of mobile telephone a consumer uses (the brand being one of some discrete number of identified brands).

As usage of the Internet has grown, qualitative market research has been adapted for online use. As examples, discussion board and online chat-based focus groups have gained increasing acceptance. These methods allow qualitative data in the form of text and rich media (i.e., digital images, video, and audio) to be relatively inexpensively collected from geographically dispersed Internet users.

However, while qualitative data is easily collected by these methods, it is still time-consuming and tedious to categorize, aggregate, and otherwise process the collected data to generate a deliverable report with summary observations and conclusions. This is currently a significant limitation for Internet-based online qualitative research: the ability to collect the data has been made more speedy and inexpensive, but the ability to process it has not. Thus, it would be useful to have available further systems and methods of conducting online research which ease both data collection and processing.

### SUMMARY OF THE INVENTION

The invention involves methods of conducting online research, in particular consumer/market qualitative data research, and online systems for enabling such research. To give the reader a basic understanding of some of the advantageous features of the invention, following is a brief summary. Since this is merely a summary, it should be understood that more details regarding the preferred versions may be found in the Detailed Description set forth elsewhere in this document. The claims set forth at the end of this document then define the various versions of the invention in which exclusive rights are secured.

An online research system (e.g., a web-based software application) assists in online research by use of the following steps. As will be discussed below with respect to FIG. 2, research participants, e.g., consumers whose spending decisions are of interest, can be identified by reviewing data regarding research participant characteristics. As an example, questionnaires can be provided to consumers which identify the market segments in which they fit, such as age ranges, income, interests, use of certain product types, etc., and the data from such questionnaires can be supplied to and/or maintained by the research system. The researcher operating the online research system can then identify the particular segment(s) of interest for the research project to be conducted—for example, people between the ages of 20-30 who are about to purchase a new mobile telephone—and use the consumers within the segment(s) as the research participants for the research project.

As will be discussed with respect to FIG. 3A, the researcher can also compose and collect online queries to be delivered to the research participants of interest, wherein each online query solicits feedback from the research participants on one or more topics relevant to the objects of the research project (and wherein exemplary queries are illustrated in FIGS. 5A, 5B, and 5C). These queries are preferably each stored in association with a respective scheduled delivery time at which the query is to be delivered to the research participants. Thus, for example, the researcher might schedule a first query which simply asks the research participants to verify whether they are in the segment(s) of interest: are they within a certain age range, are they about to purchase a new mobile telephone, etc. The researcher might then schedule a second query to be delivered to the research participants at some subsequent time, with the query asking how the research participants intend to narrow their field of potential mobile telephone purchasing choices. Another query may be scheduled for delivery shortly after that, asking the research participants to submit digital images of their shopping excursions to examine mobile telephones of interest, and their general impressions of the shopping excursions (e.g., product and/or vendor features that drew their interest, etc.). Thus, the researcher effectively “scripts” the research project, with proposed queries to be sent at scheduled times. Preferably, both the content and the scheduling of queries are subject to revision by the researcher as feedback from the research participants begins to be collected.

The queries can seek feedback of two types: qualitative (unstructured) feedback and quantitative (structured) feedback. Quantitative feedback is feedback which is readily summarized by mathematical/statistical means, such as feedback to queries wherein a research participant is directed to respond with a value selected from a continuous range of values (e.g., “approximately what time do you eat breakfast each day?”). As another example, quantitative feedback may be feedback to queries where a research participant is directed to select from a predefined set of discrete values/answers to serve as his/her feedback (e.g., true-false answers, multiple-choice answers, and the like). Qualitative feedback, on the other hand, is effectively unconstrained, and consists of data (text, images/video, audio, etc.) that is freely entered by the research participant at the research participant's discretion. Thus, qualitative feedback is not readily statistically processed. As an example, qualitative feedback may be any data that a research participant supplies in response to the query “what was your impression of [selected mobile telephone model]?”, or it could be any image that a research participant supplies in response to a request to submit a photo of the storefront of his/her favorite vendor. Qualitative feedback is regarded as being particularly valuable to research because it can deliver significant and unexpected insight into research participants' thoughts and behavior. Usefully, the queries (and the means for collecting feedback therefrom) can be scheduled and provided to research participants in a format similar to blogs, message boards, chatrooms, web forms, and other common Internet-based means for collecting user input. Often, the queries and feedback collection are structured to have the research participants effectively create an online diary, with the participants' entries (their feedback) being made over time, and with their entries containing qualitative and quantitative data directed toward topics of interest by the queries.

The online queries are then delivered to the research participants in accordance with the queries' scheduled delivery times, and the researcher can collect the feedback online from the research participants (as will be discussed with respect to FIG. 6A and FIG. 6B). Delivery of queries (and collection of feedback) preferably occurs via a website (as exemplified in FIG. 5A, FIG. 5B, and FIG. 5C), whereby the research participants may access the website to see the periodically-updated queries, and may enter or attach their feedback (e.g., by entry of alphanumeric text in fields, and/or by selecting image, video, and/or audio files for delivery to the researcher/website operator). The website (or other mode of delivery of the queries) can be provided to the personal computers or other communications devices of the research participants, such as to their mobile telephones. Delivery to mobile telephones is particularly valuable because this can allow research participants to provide feedback to queries while engaged in activities relevant to the research project—for example, research participants might provide feedback to queries about selecting a new telephone while actually shopping for the new telephone. Mobile telephones and similar communication devices also allow for easy delivery of queries via audio (and/or by photo/video, provided the mobile device is photo/video enabled), as well as allowing for possible on-the-go collection of audio, photo, and/or video feedback from participants.

As will be discussed with respect to FIGS. 6A and 6B, the system preferably allows researchers to seek additional feedback from research participants outside of the scripted-and-scheduled queries. As an example, a researcher might review feedback provided by a research participant as it arrives (or shortly thereafter), and may note that some research participants are providing deficient feedback (e.g., feedback which is so vague as to be meaningless, and/or feedback which is nonresponsive to its corresponding query). Alternatively, a researcher might find that feedback provided by one or more research participants has provided unexpected information which is worthy of further investigation. In these instances, the researcher might turn to any scripted queries scheduled for future delivery to all research participants, and might revise their content and/or scheduling to better address the matter of interest. However, the system is also preferably configured to allow the sending of one or more “probes”—i.e., follow-up queries—which are delivered only to the research participant(s) from whom the researcher wishes to acquire follow-up feedback. Additionally, where the queries and feedback collection are structured similarly to a message board or chatroom—wherein other research participants may themselves leave feedback which responds to and comments on feedback left by a research participant—the feedback submitted by these other research participants may itself serve as (or help to serve as) such follow-up queries. Thus, a research project need not be constrained to the “script” provided by its prescheduled queries, and research participants may be prompted by the researcher and/or other research participants to elaborate on prior feedback.

In similar fashion, the system may be configured to allow the scripting and scheduling of future queries to be delivered to particular subsets of research participants selected from the original set of research participants chosen for the research project. In this manner, if it should become evident during the course of research that the research project involves distinct types of research participants (e.g., different “subsegments” of consumers), and these distinctions were not known or appreciated when the research project began, the researcher can more easily prepare queries tailored to the particular subsets of research participants involved.

The feedback from the research participants can then be compiled by the research system for analysis by the researcher (as will be discussed with respect to FIG. 8A, FIG. 8B, and FIG. 9). Quantitative feedback can be sorted, binned, statistically analyzed, or otherwise processed by the system, and can be presented to the researcher in numerical form, such as via means, standard deviations, or other statistical measures, and/or graphical form, such as in graphs, bar charts, scattergrams, or the like. Qualitative feedback, on the other hand, is preferably analyzed (at least in part) by “tagging” (as will be discussed with respect to FIG. 6A and FIG. 6B). Here, the researcher may review the qualitative feedback and isolate information of interest, and may assign names—“tag labels”—to different types of such information. The researcher “tags” the information of interest by assigning the appropriate tag label(s) to the relevant portion(s) of the feedback. To illustrate, a researcher might be interested in the influence of one's peers on the selection of a new mobile telephone, and might create a tag label named “Friends.” As the researcher reviews the feedback from research participants, the researcher could select text entries (or portions thereof) from research participants which mention their friends or suggest the influence of one's friends, or the researcher could select submitted images or audio files (or portions thereof) showing or implying the participation of the participants' friends, and can assign the “Friends” tag label to the selected matter. The research system can maintain a list of the tag labels, and of the tagged feedback, so that the researcher can readily review the tagged feedback by referencing its tag label. F or example, by mousing to, and clicking on, a particular tag label within a list, the related tagged feedback might be presented to the researcher.

Ideally, the researcher may apply tag labels to feedback by simply clicking on a certain item of feedback (e.g., by clicking on a research participant's reply, whether it be in text, image, video, or audio form); by running a cursor over a portion of a research participant's text entry to select the matter (words or strings) to be tagged; by pointing a cursor to and selecting a research participant's submitted image to be tagged; by “boxing” or “lassoing” a portion of the image to be tagged; by selecting an audio file to be tagged; by clicking during the playing of an audio file to indicate the start and stop times of the portion to be tagged; and so forth. Tagging could also occur automatically by the researcher instructing the research system to tag any feedback which includes a particular string, or which relates to particular research participants (e.g., those of particular interest). For example, if certain research participants indicated at the outset of the research project (or later during the research project) that they sought to purchase a new mobile telephone as soon as possible, the research system might automatically apply an “Immediate Purchaser” tag label to all feedback submitted by these research participants. This tag label, and the feedback of these participants, may be of greater interest to the researcher because they may represent the thoughts and behavior of a more “serious” consumer—one who feels a need for a product, rather than one who merely wants one—and the tag label can help the researcher more readily access data related to these participants. As another example, to assist the researcher in identifying feedback related to an actual/final purchase by a participant (with such feedback providing insight into the participant's thoughts and behaviors at the time of purchase), the research system might be instructed to automatically tag any feedback containing one or more of the strings “bought” or “paid” with the tag label “Purchase Made.” (In this case, the entire feedback string could be tagged, or some number of words around the sought “bought”/“paid” strings could be tagged.) The researcher could in this case review the automatically-applied tags and remove any that are not truly of interest, and/or the reviewer might independently review the feedback and manually apply the “Purchase Made” tag label if it appears that the automatic tagging missed some relevant feedback.

Once feedback (or a portion thereof) is tagged, the tagged matter is preferably displayed to the researcher in connection with the assigned tag label, and with a different appearance, so that it is apparent to the researcher that it has been tagged. As examples, text feedback might be “highlighted” (displayed on a differently-colored background) after being tagged; image feedback (or portions thereof) may be shown with a superimposed box after being tagged; and audio or video feedback might have shading or other marking on its timeline or clock (i.e., on the scroll bar allowing one to scroll to some time during the duration of the audio/video file). Any tag labels applied by a researcher are preferably seen only by the researcher within the research system, and are not visible to the research participants, so that the tagging and/or tag labels do not influence further feedback collected from the research participants.

At the completion of the research project, or during its administration, the researcher may review the collected feedback (as will be discussed with respect to FIG. 8A, FIG. 8B, and FIG. 9). As discussed above, quantitative data (if present) might be presented to the researcher in a summarized numeric/graphical form (or alternatively in raw form, if desired), as exemplified by FIG. 9, and qualitative data might be presented to the researcher in a summary which presents the tag labels (e.g., in a list of tag labels wherein clicking on a tag label presents the corresponding tagged feedback to the researcher for review), as exemplified by FIG. 8B. One particularly preferred mode of presenting summarized qualitative data to the researcher is in a “tag cloud” (exemplified by FIG. 8A), wherein the tag labels are presented to the researcher, and each tag label includes a visually ascertainable indication of the number of text strings, images, and/or other feedback entries corresponding to the tag label. As an example, the tag labels can be presented to the researcher in a list wherein each tag label is presented in a font size proportionate to the number of feedback entries corresponding to the tag label, so that the size of a tag label will rapidly communicate to the researcher the frequency (and thus possibly the importance) of certain themes within the feedback. Additionally or alternatively, color, capitalization, stylization (e.g., bolding), and the like can be used to indicate the density or sparseness of the information associated with a tag label.

The researcher may then use the research system to generate a report with summary observations and conclusions (as will be discussed with respect to FIG. 10), with the report being designed for delivery to the party who commissioned the research project. Here, the research system may allow a researcher to simply draft the text of his or her observations and conclusions, and insert/attach supporting data. For example, the researcher might insert/attach selected feedback entries from research participants (which might be readily selected from feedback entries corresponding to tag labels related to the topic of interest), and/or might insert/attach the aforementioned numeric/graphical summaries of quantitative data. Preferably, the research system allows delivery of the summary report in printed form (e.g., in a paper reviewing observations and conclusions and having the supporting data presented in cross-referenced appendices, or printed following each observation/conclusion), or in electronic form (e.g., in a document provided in RTF format, or in a markup language such as HTML or XML, with hyperlinks allowing a reviewer to readily move between observations/conclusions and supporting data).

To ease the administration of research projects, the research project (and its scheduled queries, collected feedback, and other tasks/events) are preferably displayed to the researcher along a timeline, e.g., a calendar or linear array of dates/times (as exemplified in FIG. 6A and FIG. 6B). Most preferably, the timeline presents dates and times in combination with a visual display of the online queries (which can be situated on the timeline at their time of delivery); the feedback collected from the research participants in response to the online queries (which can be situated at their actual time of collection, or at the scheduled deadline for collection); and the number of research participants who have (or have not) provided feedback to the online queries (these numbers being situated at the point on the timeline corresponding to the current time). Here, it should be understood that the actual online queries and their feedback need not be displayed on the timeline—this matter may be voluminous, and not readily displayed in a compact manner along a timeline—and thus the queries and feedback may be presented in iconic/symbolic form. The number of responding and nonresponsive research participants is usefully displayed along the timeline because this allows a researcher to determine whether a research project is proceeding as scheduled. To this end, and as exemplified by FIG. 6B and FIG. 7, the research system usefully provides an alert to the researcher if a research participant does not provide feedback to an online query within a predetermined time period (e.g., by the scheduled deadline, or at the time the next query is to be delivered), and the research system might also deliver a reminder to a research participant in this event (e.g., via email or voicemail). The reminder can be composed by the researcher, and can be stored by the research system in association with its related query and/or with the scheduled feedback deadline. Ideally, the display of the timeline allows a researcher to easily reschedule an event (e.g., delivery of queries) by simply dragging and dropping it along the timeline, and allows easy revision of queries or other matter by simply clicking on the matter along the timeline to open and access it for revision.

Another useful feature of the invention is that it enables a researcher to conduct a research project among one or more of the aforementioned consumer segments—i.e., among one or more defined sets of research participants—and readily redefine the segments, as by moving research participants among segments or reducing or expanding the research participants within a segment, with no or little impact on the conduct of the research project. In other words, researchers may (unless otherwise desired) redefine segments without altering the content or delivery of queries, the collection and processing of feedback, the generation of reports, etc.

Further advantages, features, and objects of the invention will be apparent from the remainder of this document in conjunction with the associated drawings.

### BRIEF DESCRIPTION OF THE DRAWINGS

FIG. 1 is a screenshot of an exemplary software application wherein a researcher is accessing a “Setup” option on the uppermost navigation bar, and a “Settings” suboption beneath, to allow the researcher to set the basic parameters for a research project (e.g., the project name, the website at which the research project will be offered to research participants, etc.)

FIG. 2 is a screenshot of the exemplary software application wherein a researcher is accessing the “Setup” option on the uppermost navigation bar, and a “Participants” suboption beneath, to allow the researcher to enter and/or edit details regarding the characteristics of research participants.

FIG. 3A is a screenshot of the exemplary software application wherein a researcher is accessing the “Setup” option on the uppermost navigation bar, and an “Activities” suboption beneath, to allow the researcher to script queries for delivery to research participants (with the queries being provided in sets referred to as “Activities”). A “New Activity” menu is also shown in the lower left-hand side of FIG. 3A, with the “Elements” option being chosen on the menu, allowing the researcher to specify elements to be used in scripting a query.

FIG. 3B illustrates the “New Activity” menu of FIG. 3A in the event the “Templates” option is chosen, with the “Templates” option allowing the researcher to rapidly insert into a query some predefined set of the foregoing “Elements”.

FIG. 3C illustrates the “New Activity” menu of FIG. 3A in the event the “Stimuli” option is chosen, with the “Stiniuli” option allowing a researcher to insert some sort of stimulus—text passage, image, audio/video clip, etc.—into an activity, for use as the subject of one or more subsequent queries.

FIG. 4 illustrates an “Activity Settings” control panel which might be displayed if the researcher scrolled to the bottom of the “Activities” screen of FIG. 3A, with the activity settings allowing the researcher to specify further details regarding how the activity (and the queries therein) should be presented to research participants.

FIG. 5A, FIG. 5B, and FIG. 5C then present screenshots of activities (and the queries therein) that might be scripted by use of the research system and delivered to research participants.

FIG. 6A is a screenshot of the exemplary software application wherein a researcher is accessing the “Moderate” option on the uppermost navigation bar, and an “All Segments” suboption beneath, to allow the researcher to view and tag feedback provided by all research participants for the research project.

FIG. 6B is a screenshot of the exemplary software application similar to FIG. 6A, but wherein the researcher is accessing the “Group 3” suboption below the “Moderate” option on the uppermost navigation bar, thereby allowing the researcher to specifically view and tag feedback provided by a segment (subset) of the research participants for the research project (more specifically, the segment “Group 3”).

FIG. 7 is a screenshot of the exemplary software application wherein a researcher is accessing the “Dashboard” option on the uppermost navigation bar, and an “Overview” suboption beneath, which provides the researcher with a summary of the status of the research project.

FIG. 8A is a screenshot of the exemplary software application wherein a researcher is accessing the “Analyze” option on the uppermost navigation bar, and a “Tags” suboption beneath, providing the researcher with a view of tag names which the researcher has applied to the qualitative (unstructured) data of the feedback collected during the course of the research project (with the tag names here being presented in the form of “tag clouds” wherein the size of the tag names reflects their frequency of use).

FIG. 8B is a screenshot of the exemplary software application wherein the researcher is again accessing the “Analyze” option on the uppermost navigation bar, and a “Tags” suboption beneath (as in FIG. 8A), but wherein the researcher is viewing the tag names in a grid/tabular form.

FIG. 9 is a screenshot of the exemplary software application wherein the researcher is again accessing the “Analyze” option on the uppermost navigation bar, and an “Activity Grids” suboption beneath, thereby displaying to the researcher selected quantitative (structured) data collected from the research participants during the research project.

FIG. 10 is a screenshot of the exemplary software application wherein the researcher is again accessing the “Analyze” option on the uppermost navigation bar, and a “Findings” suboption beneath, allowing the researcher to draft summary observations/conclusions concerning the feedback from the research participants (and allowing selected supporting items of feedback to be “attached” below).

FIG. 11 is a flowchart illustrating the aforementioned “Dashboard” option (FIG. 7), “Setup” option (FIG. 1-FIG. 3A), “Moderate” option (FIG. 6A-FIG. 6B), and “Analyze” option (FIG. 8A-FIG. 10) of the uppermost navigation bar of the exemplary software application, as well as subobtions offered beneath these options.

FIG. 12 is a flowchart illustrating subobtions available to the researcher under the “Participants” suboption (FIG. 2) and “Activities” suboption (FIG. 3A-FIG. 3C) of the “Setup” option of the uppermost navigation bar of the exemplary software application.

### DETAILED DESCRIPTION OF PREFERRED VERSIONS OF THE INVENTION

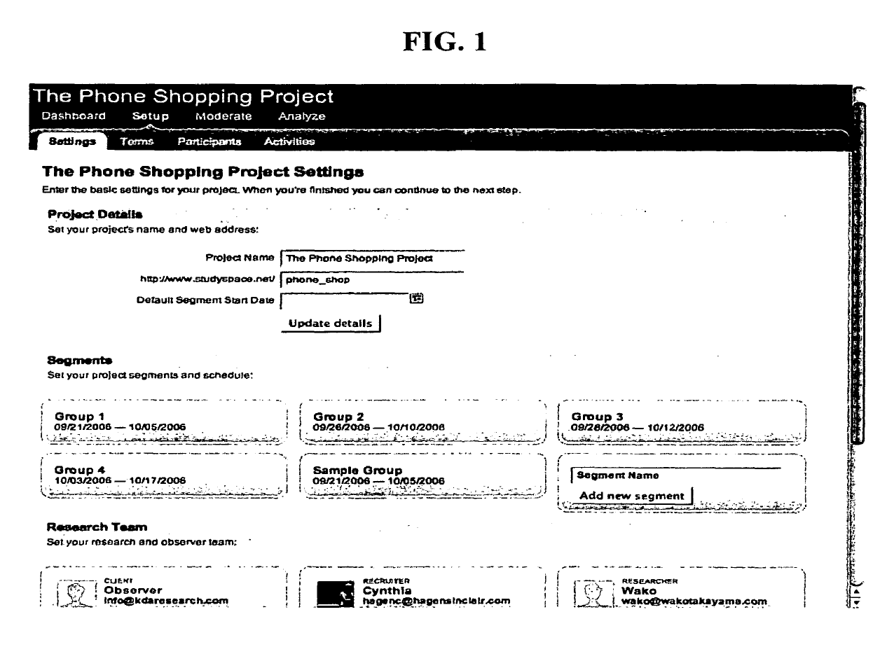

Following is a review of a preferred version of an Internet-based software application which illustrates the features discussed above. Initially referring to FIG. 1, which presents a screenshot of the exemplary application, a researcher is able to define the basic parameters for a research project by choosing a “Setup” option from an uppermost navigation bar, and then choosing the suboption “Settings.” These options bring a researcher to the screen depicted in FIG. 1, which may be accessed by the researcher before or after a research project has been initiated. Under the heading “Project Details,” a researcher is allowed to perform tasks such as:

(1) assigning a name to the research project (in the “Project Name” field, with the name “The Phone Shopping Project” being applied here);

(2) assigning the URL (web address) at which the research project can be implemented, whereby research participants may later access and log onto the website to receive queries and submit feedback;

(3) assigning (if desired) a proposed date and time (“Default Segment Start Date”) on which the website will be made available to all research participants. Since the website may be made available to research participants across numerous time zones, this preferably also includes an option to also set the default time zone under which the research system will operate.

Also in FIG. 1, under the heading of “Segments,” a user may create and assign segments—i.e., particular species of research participants—to the research project, for collection of their feedback. Segments could encompass, for example, consumers who reside within a particular region; consumers of a particular gender; consumers who are business purchasers, as opposed to merely being everyday consumers; consumers in certain age ranges; consumers within certain income ranges; consumers of particular products/brands; consumers who are novice or expert users of a product; and so forth. Segments can also constitute combinations of the foregoing (or other) categories, e.g., male computer users between the ages of 20-25, homeowners with dogs having a certain income range, and so forth. The creation of segments and the assignment of research participants to segments, will be discussed below. In FIG. 1, a researcher can assign existing segments to a research project by filling in the name of a segment in the field above the “Add new segment” button (or, if this field is a drop-down menu or the like, the researcher could choose the name of a desired segment from the menu). Once the “Add new segment” button is clicked, the segment will be displayed in the same manner as the segments “Group 1,” “Group 2,” “Group 3,” “Group 4,” and “Sample Group” displayed in FIG. 1. Clicking on the segment allows the researcher to set start and finish dates for the research project, as applied to the particular segment in issue, i.e., different segments may have different start and finish dates. The finish date may be automatically determined by the research system if the start date is known, and if the researcher has defined the number of days over which queries are to be issued to—and feedback will be collected from—the research participants.

Also in the screen of FIG. 1, under the heading “Research Team,” a researcher may designate the team (if any) which may collaborate on the research project. Here, the name and contact details of the researcher(s) who will script queries, analyze feedback, etc. may be entered, as well as the name and contact details of any recruiter(s) for interviewing and/or recruiting proposed research participants. The names and details of others, e.g., the “client” (the party who commissioned the research project) or other observers, might be added as well. The researcher(s), recruiter(s), and observer(s) may all be granted varying degrees of access rights to different features of the research system and the data collected therefrom. As an example, a client might only be allowed to review queries and feedback as an observer, without being able to communicate with research participants, or alternatively the client may be able to participate as fully as a researcher in the research project.

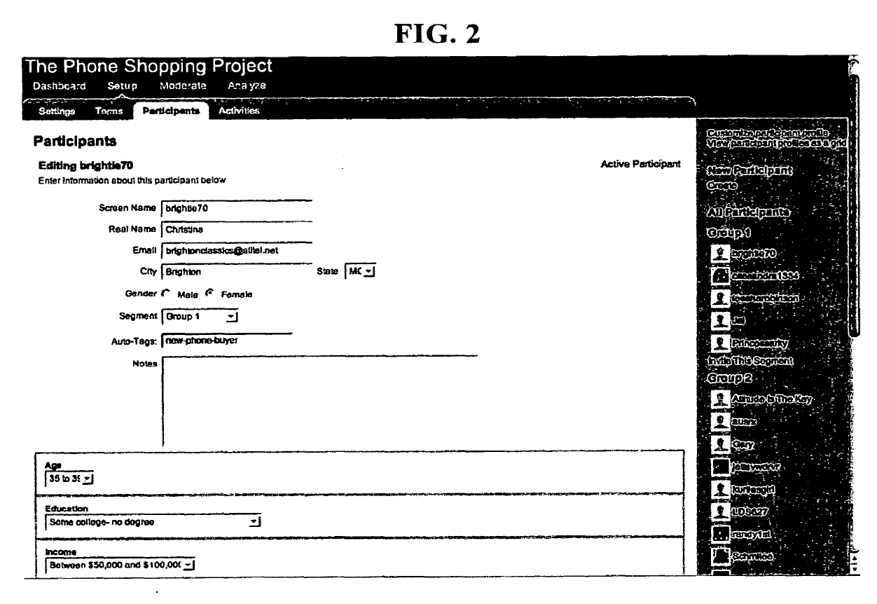

FIG. 2 then presents the screen seen by the researcher when the researcher selects the “Setup” option from the uppermost navigation bar, and then chooses the suboption “Participants.” Here, the researcher or recruiter can enter or edit the “Participant Profile”—i.e., data regarding the characteristics of research participants—and/or select research participants (or segments of participants) of interest for the research project. Beneath the heading “Participants,” a number of “Participant Profile” fields for entry or editing of research participant data are displayed: the screen name to be used by the research participant as the research participant participates in the online research project; the research participant's real name; the research participant's e-mail address; the research participant's city of residence; the research participant's gender; and so forth. The data in these fields may be entered by a researcher or recruiter, or alternatively, if the research system is drawing from a previously-created “Participant Pro file” database of research participant characteristics, the illustrated values in the fields may simply be drawn from the database.

Two of the illustrated participant characteristic fields in FIG. 2 are of particular note, the “Segment” and “Auto-Tags” fields. The “Segment” field can be used to assign a research participant to a particular segment via choice of a named segment from a drop-down menu. The “Auto-Tags” field is then an optional field which a researcher (or recruiter, etc.) may use to automatically assign a tag to all feedback provided by the research participant in question. For example, if the research project relates to consumer experiences while seeking a new mobile telephone, a researcher may later wish to look specifically at the experiences of consumers who have not previously purchased or owned a mobile telephone. In this case, a researcher might assign the tag label of “new user” or the like in the Auto-Tag field to participants who meet this condition, so that the research system will automatically tag any feedback from these particular research participants with the “new user” tag. This allows the researcher to more easily categorize and access the responses of these research participants. Note that alternatively, the researcher could simply create a “new user” segment and assign these research participants to this segment. However, in some cases, certain consumer characteristics may not serve well to define segments since apart from the characteristic in question, the consumers within the segments may in reality be very diverse. To illustrate, a researcher might wish to compare and contrast differences between research participants in New York City, Baltimore, and Philadelphia, but depending on the nature of the research project, it may be inappropriate to define segments based on the geography of the research participants—age, gender, socioeconomic status, and the like may be more relevant. In this case, the researcher can use the Auto-Tag feature to assign tags to the research participants in accordance with their geography, and can later use the tags to rapidly compare/contrast their feedback. Thus, the Auto-Tag feature provides a useful way to track feedback from consumers in different segments, but wherein the consumers share some characteristic of interest.

Looking to the right-hand side of FIG. 2, it is seen that several segments and participants are already present in the research system's database, have been selected to participate in the research project, and are listed under the heading “All Participants.” The different segments selected for participation—here generically presented as “Group 1” and “Group 2”—are illustrated along with icons and screen names corresponding to the research participants within those segments. (The icons may be replaced with images of the research participants or of other matter if such images are loaded into the research system.) Underneath each segment, an “Invite this Segment” link is provided whereby the researcher clicking on the link will forward an invitation by email or other means to all (potential) research participants within the segment to join in the research project. Preferably, the invitation to the potential research participants will include the terms of participation in the research project, e.g., legal terms regarding compensation for their participation, privacy/confidentiality provisions, etc. These terms may be established by the researcher in a fill-in field which is accessible under the “Terms” suboption on the navigation bar, and which is not depicted in the drawings. Alternatively or additionally, the terms may be presented to research participants when they initially access the website at which the research project is offered, and/or at subsequent “log-ins” thereafter, and the research participants may be required to affirmatively indicate their acceptance to the terms (as by clicking an “I Accept” button).

Other links shown at the right-hand side of FIG. 2 include “Customize Participant Profile,” “View Participant Profiles as a Grid,” and “Create” (this last link being under the heading “New Participant”). By clicking on “Customize Participant Profile,” the research system allows a researcher to add (or remove) “Participant Profile” fields regarding research participant characteristics (e.g., gender, income range, profession, experience with/frequency of use of some product, etc.). The link “View Participant Profiles as a Grid” allows the researcher to display the participant data for a chosen segment in tabular form, thereby providing an at-a-glance view of the research participants within a segment. The “Create” link under the “New Participant” heading allows a researcher to add a new research participant to the “All Participants” list below.

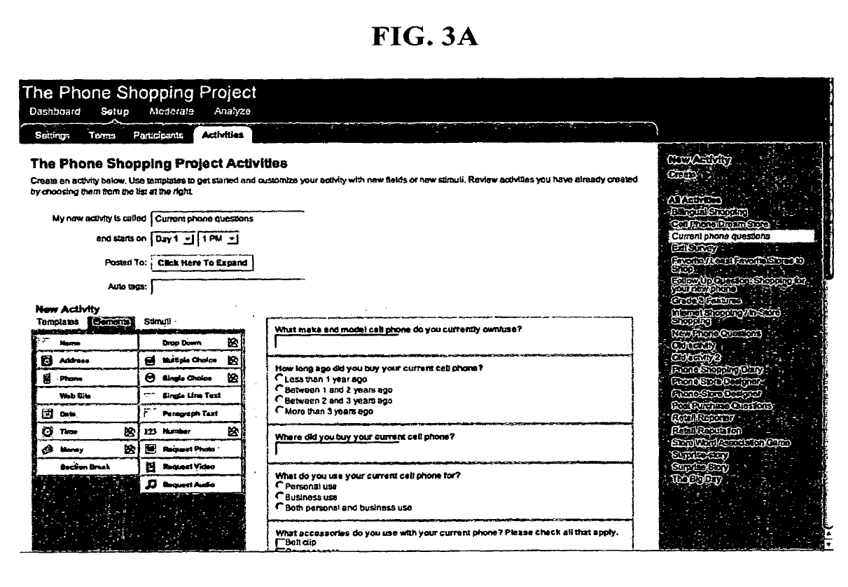

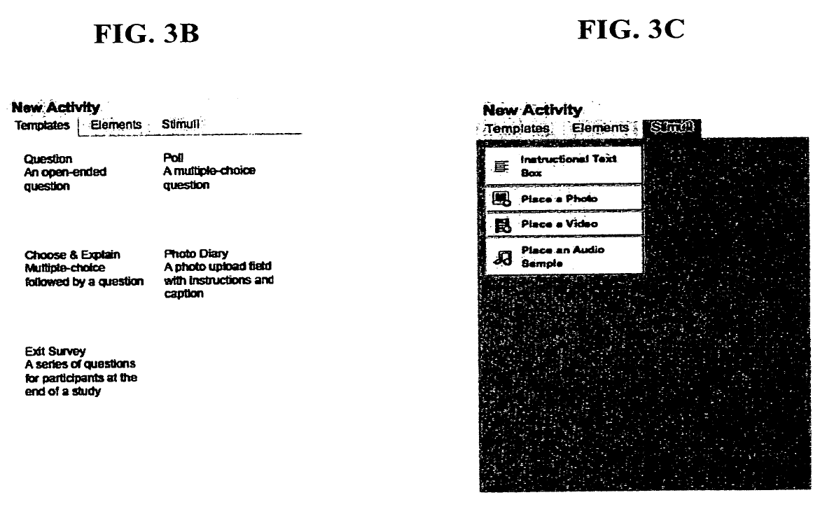

Turning next to FIG. 3A, the researcher may script queries to be delivered to research participants by accessing the “Setup” option and “Activities” suboption of the uppermost navigation bar. Here, the queries are grouped into sets referred to as “activities,” wherein each activity includes one or more queries (usually several). In general, each research project will contain several activities spaced over time, with each activity containing several queries. Previously-created activities are displayed by name at the right-hand side of FIG. 3A, under the heading “All Activities.” A new activity may be created by use of the “Create” link presented above under the heading “New Activity.” The researcher may assign a name to an activity (or edit an activity name) by entering the desired name in the “My new activity is called” field; may set a delivery time and date for the activity in the “and starts on” fields (with the activity and its queries then being posted on the research project's website on the specified date and time); and may specify the research participant(s) or segment(s) to receive the activities' queries by choosing the desired segment(s) from the menu adjacent to “Posted To:”. Here, when the “Click Here to Expand” button adjacent “Posted To:” is clicked, the button disappears and a drop-down box displays a grid of all the segments and the research participants therein. Desired segments and/or particular research participants may then be selected or deselected to receive (or not to receive) the activity and the queries therein. Also, similarly to the screenshot of FIG. 2, the researcher may add one or more tags in the “Auto Tags” field so that any feedback provided in response to the activity's queries will automatically be tagged with the entered tag label.

Below these fields in FIG. 3A, and under the heading “New Activity,” a researcher may script the queries to go into an activity via the “Templates,” “Elements,” and “Stimuli” tabs, wherein the options under the “Elements” tab are shown in FIG. 3A, and the options under the “Stimuli” and “Templates” and tabs respectively being shown in FIG. 3B and FIG. 3C. Beneath the “Elements” tab of FIG. 3A, a number of buttons are shown below which allow a researcher to select various elements to go into a query (which appears in the query field to the right). For example, the researcher's selection of the “Name” button will insert a text field for the researcher (so that the researcher may insert a query such as “what is your name?”), as well as a series of first name/middle name/last name feedback fields situated beneath the query text field. As another example, the researcher's selection of the “Address” button will insert a text field wherein the researcher may insert a “what is your address?” query or the like, as well as inserting feedback fields for a street number, street name, city, state, and postal code beneath. As a final example, the researcher's selection of the “Request Photo,” “Request Video,” and “Request audio” button will insert a text field wherein the researcher may request that the research participant attach an image, video, or audio file, as well as inserting a “browse” button beneath whereby a research participant may attach the requested file. Note that options/buttons which request quantitative data (“Time,” “Money,” “Drop Down,” “Multiple Choice,” “Single Choice,” “Number”) are also specially indicated by the use of an adjacent symbol representing a graph/curve. As a researcher enters queries, he/she may space or separate them by use of the “Section Break” button. As a researcher selects “Elements” and customizes their content, the resulting scripted queries appear in the query field. To illustrate, in FIG. 3A, a “Single Line Text” field is presented in the query field beneath the question “What make and model cell phone do you currently own/use?”; a “Section Break” then follows; a set of “Multiple Choice” fields follow the question “How long ago did you buy your current cell phone?”; another “Section Break” follows; and so forth.

If the researcher chooses the “Stimuli” tab beneath the “New Activity” heading of FIG. 3A, the menu shown in FIG. 3B appears. The “Stimuli” menu allows the researcher to insert some stimuli into the query field for which the research participants are to answer queries. In FIG. 3B, the exemplary stimuli are depicted as:

(1) an instructional text box, wherein a researcher might enter some text for which the researcher wishes to pose queries (for example, proposed advertising copy, a description of a purchasing scenario, etc.);

(2) the “place a photo” option allows the researcher to insert an image before, after, or within the queries of an activity so that research participants may subsequently answer queries posed by the researcher about the image;

(3) the “place a video” option allows the researcher to insert avideo before, after, or within the queries of an activity (along with controls whereby research participants may start/stop/replay the video) so that research participants may subsequently answer queries posed by the researcher about the video; and

(4) the “place an audio sample” option allows the researcher to insert an audio clip before, after, or within the queries of an activity (along with controls whereby research participants may start/stop/replay the clip) so that research participants may subsequently answer queries posed by the researcher about the clip.

If the researcher chooses the “Templates” tab beneath the “New Activity” heading of FIG. 3A, the menu shown in FIG. 3C appears. The “Templates” are simply selected ones of the foregoing elements of FIG. 3A and FIG. 3B (and/or combinations of the foregoing elements) which tend to be used with greater frequency by researchers. Thus, presenting these commonly-used elements in the “Templates” option can allow more rapid construction of queries. For example, selecting “Question” will place an open-ended question in the query field, followed by an entry field for a single line of text (and wherein the question's text is entered by the researcher, such as “What make and model cell phone do you currently own/use?” in FIG. 3A). As another example, “Choose and Explain” will place a researcher-defined multiple-choice question in the query field (such as “How long ago did you buy your current cell phone?” and its accompanying answer choices in FIG. 3A), and follow it with a researcher-defined question (such as “where did you buy your current cell phone?”). Clicking the “photo diary” link provides a “browse” button whereby a research participant may browse to the location of an image file for attachment, along with stock instructions to the research participant for attaching the photo, and a researcher-definable caption wherein the researcher may request a photo of a particular type. Clicking on the “exit survey” link will place a stock set of questions in the query field relating to a research participant's experiences during a research project, such as “How much time did you spend on the project?”, “Did you enjoy it?”, “Was the offered compensation adequate”, etc. The feedback to the exit survey queries is usually compiled separately from the other feedback from the research participants, and is merely used to collect suggestions that may be useful to improve future research projects. All of the foregoing templates are merely exemplary, and preferably the researcher is allowed to construct other or additional templates which present further desired combinations of elements from FIG. 3A and FIG. 3B as the researcher desires.

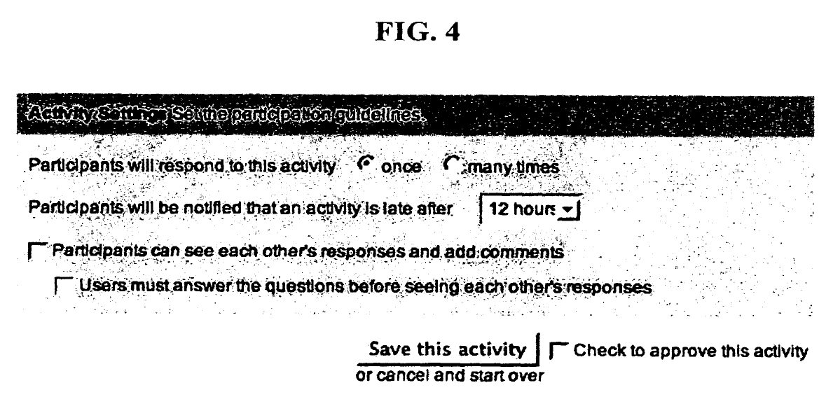

FIG. 4 illustrates an “Activity Settings” control panel which is provided at the bottom of the query field in FIG. 3A, but which is not visible in FIG. 3A. The activity settings allow the researcher to specify further details regarding how the activity (and the queries therein) should be presented to research participants. In the exemplary activity settings menu here, researchers may specify:

(1) Whether research participants will respond to the activity being scripted either one time only (i.e., once the research presenters provide feedback to the activity, the research participants do not see the activity again), or more than one time (e.g., the research presenters may be presented with the activity every time they access the research project, or at least one time per every day that they access the research project).

(2) The time interval between the posting of the activity to its specified segment/research participants, and the time at which participant feedback is at least nominally due. For example, when the time interval has elapsed, an email reminder might be sent to the research participants if they have failed to provide the feedback to the queries. Alternatively, the activity might simply become inaccessible to research participants.

(3) Whether research participants can see other research participants' feedback to the queries within the activity and add further feedback, and whether research participants must provide their own feedback before they can view the feedback of other research participants.

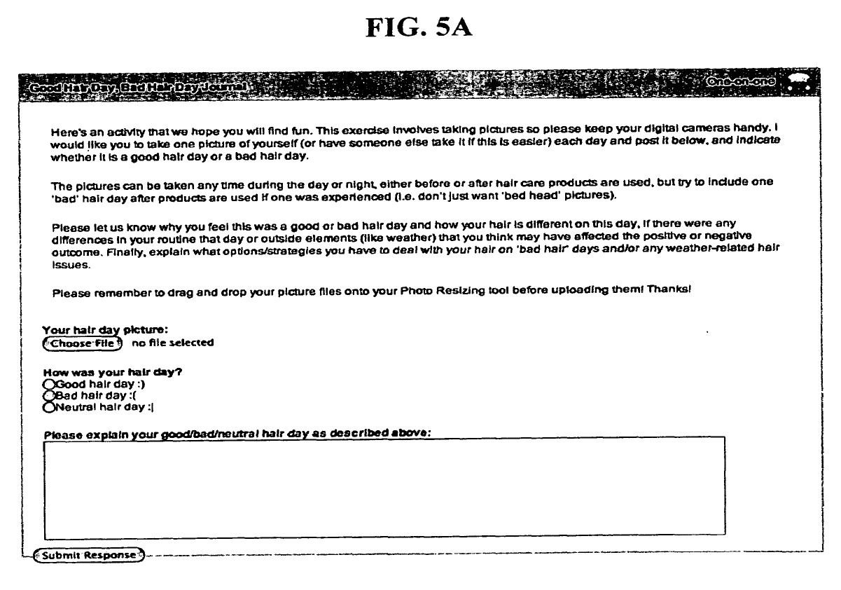

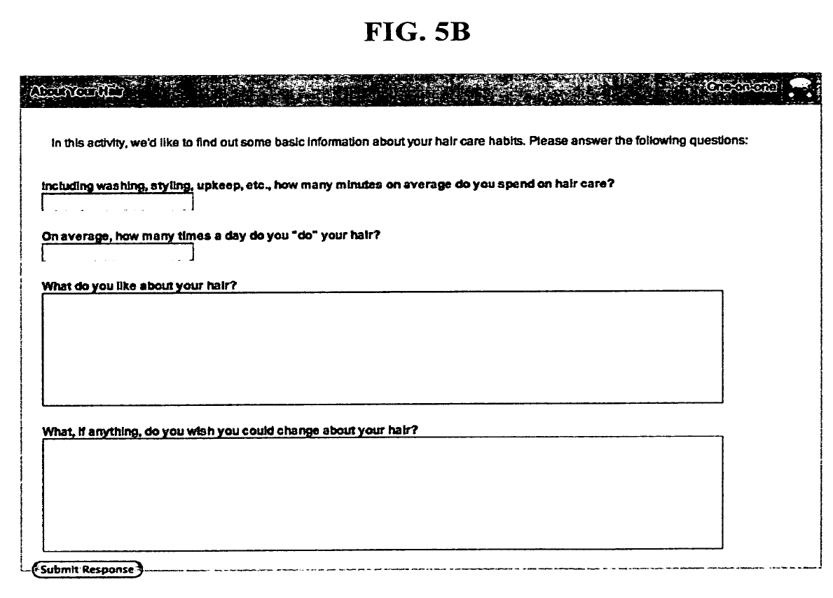

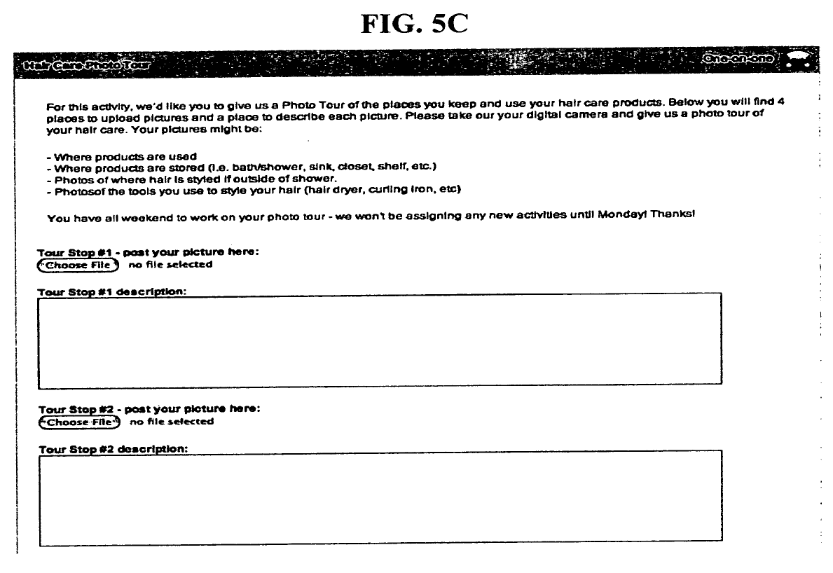

FIG. 5A, FIG. 5B, and FIG. 5C all provide examples of activities as they might appear to research participants after accessing the website at which the research project is provided (or after otherwise accessing the research project). It is notable for clarity's sake that these all relate to research projects other than the “Phone Shopping Project” depicted in prior screenshots. As previously noted, the activities would become available to the research participants to which they are assigned, and at the assigned time. In these examples, blocks of text are provided as a stimulus at the outset of each activity, with several queries following the stimulus. FIG. 5A, which presents an activity entitled “Good Hair Day Bad Hair Day Journal”, is an example of an activity that may be scheduled for ongoing/repeated delivery to research participants. It asks the research participant to attach a picture of their hair on that particular day, and asks queries regarding their perceptions about their hair. This set of queries (i.e., this activity) may be presented to research participants every day, either alone or with other activities (such as those of FIG. 5B and FIG. 5C).

It is emphasized that the queries/activities may be presented to research participants in a wide variety of formats. Often, they are presented to research participants as periodic “questionnaires” which may be presented to research participants at frequencies ranging from one questionnaire/activity per every few days, to several questionnaires/activities per day, with the frequency possibly varying over the course of the research project. However, the questionnaires will generally differ from common consumer research questionnaires/surveys in that they will usually seek a greater amount of unstructured data (i.e., qualitative data). Thus, the queries/activities will often resemble common Internet-based forums such as blogs (weblogs, i.e., websites where a user can post his/her comments); message boards (websites where several users can post their comments, with users being able to view prior posts and comment on them in their own posts); chatrooms (websites similar to message boards wherein entries are often posted via instant messaging); and the like. Queries/activities which include diary-type activities, wherein the user is asked to provide feedback on an ongoing basis—e.g., feedback regarding the purchasing process for a new mobile telephone—can be particularly useful. The degree of interaction between a research participant and the researcher (and/or other research participants) can vary between activities and research projects. For example, as discussed below, the research system preferably allows a researcher to direct follow-up queries (also referred to as “probes”) to one or more particular research participants (if desired), and a researcher may send such follow-up queries regularly, such that the research project assumes the form of a chat between the researcher and research participant. In other cases, the research participants' feedback may be visible to each other, and may serve as additional stimuli for the submission of further feedback, much in the nature of a message board (and here, the researcher's follow-up queries may effectively place him/iher in the position of a “moderator” for the message board). In other cases, a research participant may only receive one or a few queries, and may be directed to provide feedback to this same query/queries on an ongoing basis, without interaction with other research participants and with no or little interaction with the researcher apart from the research system's delivery of the researcher's queries to the research participant. Here, the research participant's feedback may largely assume the form of a web diary.

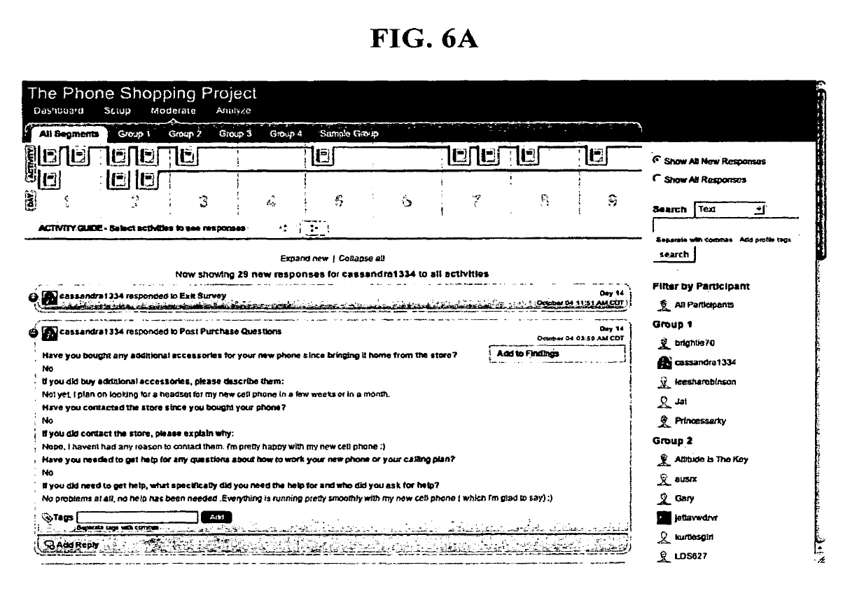

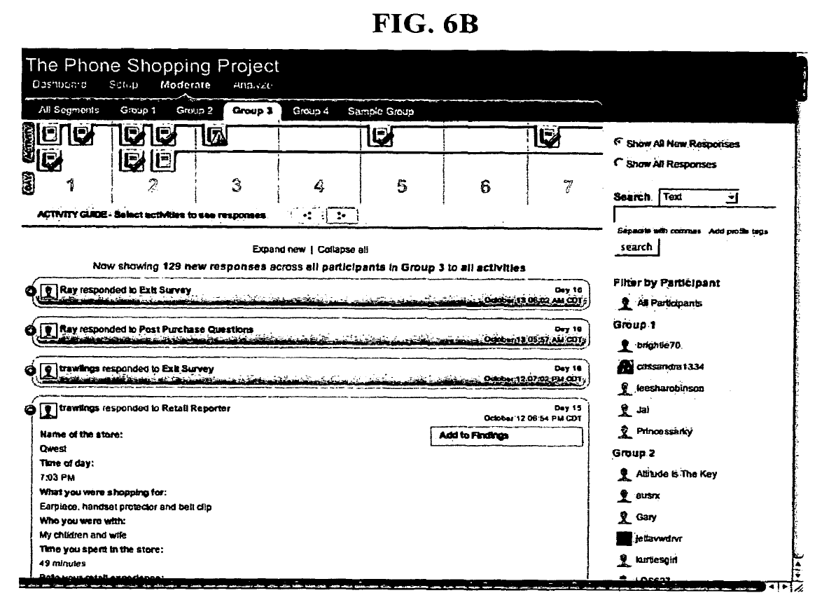

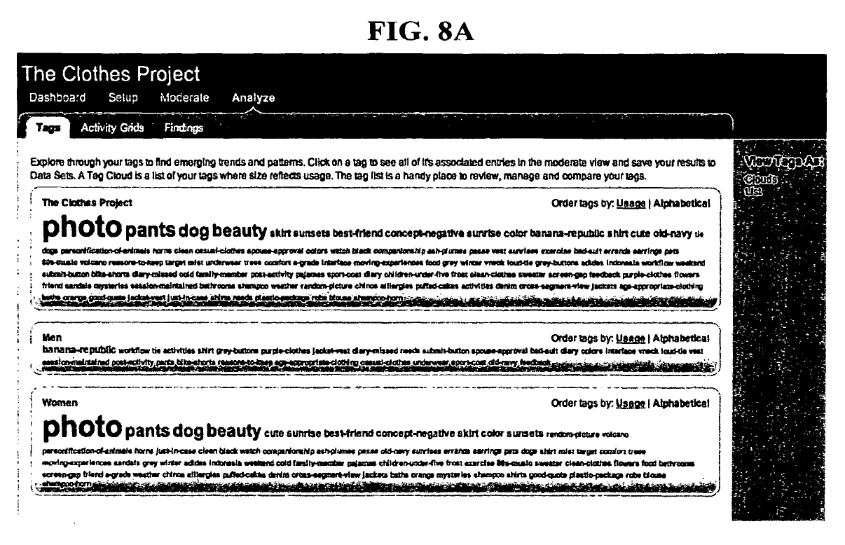

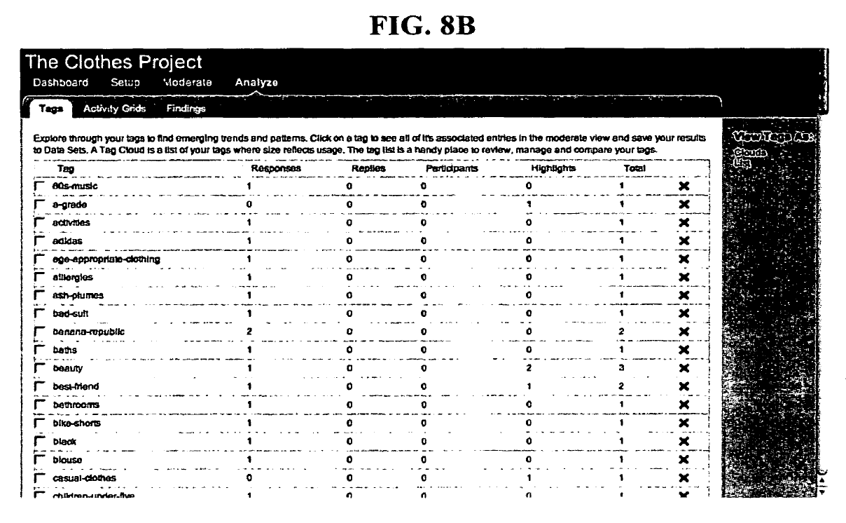

FIG. 6A and FIG. 6B then provide screenshots of how the research system may present the research project to the researcher after the project is launched. Here, under the uppermost navigation bar, the researcher has selected the “Moderate” tab, allowing him/her to view queries (by activity) along a timeline (here presented as a horizontal row of dates). Beneath the timeline, left/right arrows are provided whereby the researcher may index to a date of interest. The activities and their queries are preferably represented as icons along the timeline since presenting the full text (and other content) of the queries along the timeline would often require significant space on the monitor or other device upon which the researcher views the research project. However, the icons can bear alphanumeric characters, color coding, or other indicia which provide an at-a-glance indication of the nature of an activity and/or the segment(s) it is offered to. As an example, the left-hand sides of the activity icons illustrated in FIG. 8 include a vertical bar, and the color of this bar can signify whether a research participant's feedback to the activity is to be private or public (i.e., whether a research participant's feedback is viewed by other research participants or not). As other examples, the icons themselves can also be color coded to illustrate the segment(s) to which they are to be delivered, the launch and/or completion status of the activity (i.e., whether the activity has been made accessible to research participants and/or whether all research participants have submitted their feedback to the activity), and/or other details of the activities. The icons can also bear indicia relating to the nature and/or status of an activity, e.g., icons could bear an alphanumeric string to indicate that one or more queries therein seek text feedback, a small image of a camera to indicate that one or more queries seek images, and so forth. In similar respects, note that certain activities are depicted as having a horizontal bar extending from them, and moving forwardly along the timeline. This bar indicates that the activity is ongoing, e.g., it might be viewed by the specified research participant(s) many times (as discussed with respect to FIG. 4 and the activity of FIG. 3A).

In FIG. 6A, underneath the “Moderate” option on the uppermost navigation bar, the researcher has selected the tab “All Segments”, which displays all activities to be delivered to all segments along the timeline. However, if the researcher was to instead to choose the adjacent tabs for the segments “Group 1,” “Group 2,” “Group 3,” etc., the activities along the timeline will be filtered so that only the activities directed to the particular chosen segment are shown, as will be discussed below with respect to FIG. 6B.

If a researcher clicks on an activity icon in FIG. 6A or in FIG. 6B, the feedback from the research participants to the queries within the activity, and preferably the queries themselves, are displayed in a response field below the timeline. Preferably, the feedback is organized by research participants, i.e., each research participant who provided feedback to the activity is listed by name (or screen name/user name), and the feedback from each research participant follows their name. To conserve screen space, each research participant's feedback may only appear once the “+” sign adjacent his/her name in the list is clicked (at which point it changes to a “−” sign), and his/her feedback may again be hidden if the “−” sign is clicked. The feedback can be filtered by segments and participants by use of the segments/participant buttons presented at the right of FIG. 6A, under the heading “Filter by Participant”. At the top of the right-hand side of the screenshot of FIG. 6A, the researcher also has the option of “Show All Responses”, which indeed shows all responses (feedback) for the selected segment(s) and research participant(s) (preferably in reverse chronological order), or “Show All New Responses”, which shows only responses for the selected segment(s) and research participant(s) which the researcher has not previously reviewed. While not depicted, additional filtering options may be added, e.g., a “Filter by Query” button might be provided which displays to the researcher all queries within the selected activity, and upon the researcher's selection of one or more of the queries, the response field might only show research participant feedback to the chosen query or queries.

Below the response field in FIG. 6A and FIG. 6B, a “Tags” field is provided for use in tagging feedback within the response field. The researcher can tag a desired text string within the feedback by simply placing a cursor next to the passage, performing a click-and-drag operation to highlight the text to be tagged, and then entering a new tag label within the “Tags” field below and clicking “Add”. Similarly, images, video, and audio files can be tagged by the researcher by simply clicking on them, entering a new tag label within the “Tags” field below, and clicking “Add”. If the researcher intends to reuse a tag label (e.g., to tag numerous text strings with the same tag label), rather than requiring the researcher to retype the full tag label every time he/she wishes apply a tag, the “Tags” field might present a lookup feature: as the researcher types the tag label into the “Tags” field character by character, the “Tags” field will display the alphanumerically closest tag label, which the researcher may either select by pressing the “Add” button or reject by continuing to type further characters of the desired tag label.

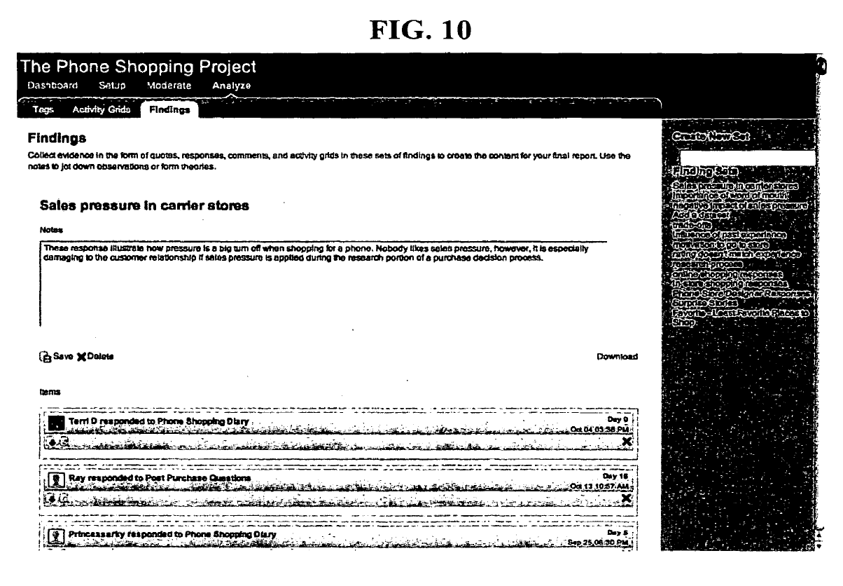

In FIG. 6A and FIG. 6B, it can also be seen that an “Add to Findings” button appears when a research participant's feedback to an activity is displayed. The researcher may use this button to add the displayed feedback to a particular “Finding,” i.e., to a qualitative conclusion/observation regarding the research project. Findings will be discussed below in reference to FIG. 10. Preferably, when the “Add to Findings” button is clicked, a list of the researcher's previously-generated findings appears so that the researcher can select the finding to which the feedback is to be added, and/or the researcher may generate a new finding to which the feedback is to be added. Also, it can be useful to allow the researcher to select only a portion of a research participant's feedback to add to a finding, as by highlighting and/or clicking on the desired portion of the feedback.

In the menu to the right of the timeline in FIG. 6A and FIG. 6B, a “Search” field is also provided so that the researcher may search for certain text, image/video/audio file names, or other matter within the feedback. Preferably, the “Search” option can allow a Boolean search for multiple terms within the feedback (e.g., if two terms are entered into the “Search” field separated by commas, the research system will treat the commas as a Boolean “and” and search for a feedback entry containing both terms). The “Search” feature can also allow a researcher to search for certain text or other features in feedback only if the feedback comes from a research participant having certain characteristics (wherein those characteristics may not necessarily be common to any segment(s) wherein the research participant(s) rest). This can be done by clicking the “Add Profile Tags” link beneath the “Search” field. As noted in the foregoing discussion of FIG. 2, when biographical, socioeconomic and/or other data is collected on a research participant, some of this participant data may itself be tagged by use of an “Auto-Tag” or similar feature—for example, a researcher (or research recruiter) may assign tags to participant feedback in accordance with the city/town names wherein the research participants reside. Thereafter, a researcher could, for example, locate all feedback entries which include the string “mobile headset” by entering this term in the “Search” field—and the researcher could further locate all such feedback entries coming from research participants in Houston by also entering “Houston” in the “Search” field. In similar respects, the “Search” feature can also allow the researcher to search for feedback which has been tagged with a particular tag name. Thus, for example, a researcher might search for feedback from research participants which includes the string “friend”, “friends”, “friendly”, and the like, from research participants in Houston, and which has previously been tagged with the tag label “Disappointment”, by entering “friend*, [Houston], <disappointment>” in the “Search” field. Here, the commas are used to signify Boolean “and”, the asterisk “*” is used as a wildcard/truncation operator, the square brackets signify that the term therein is an “auto-tagged” profile tag, and the V-brackets signify researcher-applied tags. This is merely an example, and it should be understood that a wide variety of alternative or additional search schemes could be used.

FIG. 6B then illustrates a screenshot corresponding to FIG. 6A, but wherein the researcher has selected the segment “Group 3” underneath the “Moderate” option on the uppermost navigation bar, rather than selecting the tab “All Segments” (as in FIG. 6A). Here, only the activities delivered to the “Group 3” segment are shown on the timeline. Note that certain days along the timeline include more than one activity; for example, day 1 includes three activities, day 2 includes four activities, day 3 includes one activity, day 4 has no activities, etc. A comparison with FIG. 6A also illustrates that during the research project, some segments may receive activities that others do not—for example, note that the “Group 3” segment only receives one of the activities shown at day 7 of the research project in FIG. 6A. FIG. 6B also shows checkmark indicia appearing atop those activities along the timeline for which all research participants assigned those activities have provided feedback to all queries. On the other hand, if one or more research participants fail to fully respond to all queries within an activity within the preset deadline for doing so (this deadline being set by use of the options in FIG. 4), the activity is depicted along the timeline of FIG. 6B with a warning sign (e.g., the exclamation point shown on the activity icon at day 3). When the researcher places a cursor over the activity, a pop-up window may occur (shown in FIG. 6B as the “Phone-Store Designer” window) showing the number of research participants that have fallen behind in providing feedback for this activity. This window may include additional features, e.g., clicking the “EDIT” button may allow the researcher to return to FIG. 3A or an associated screen to edit the activity. The “Show Responses” button has the same functionality as clicking on the activity icon itself, and displays the feedback associated with the activity in the response field below the timeline.

In FIG. 6B, below the response field displaying the research participant feedback (and the corresponding queries), an “Add Reply” link is shown. This allows a researcher to specifically direct “probes”—i.e., follow-up queries (and/or stimuli)—to a research participant. This can be useful, for example, if a research participant's feedback seems unclear or incomplete, and/or if the researcher wishes to further explore some unexpected issue which has arisen as a result of the research participant's feedback. Alternatively, the researcher could go back to the “Activities” tab of the “Setup” option on the uppermost navigation bar (as per the foregoing discussion of FIG. 3A and FIG. 3B) and add a new activity, or edit current or future activities, to account for the issue, and the edited/added activities can be specified for delivery to some or all research participants.

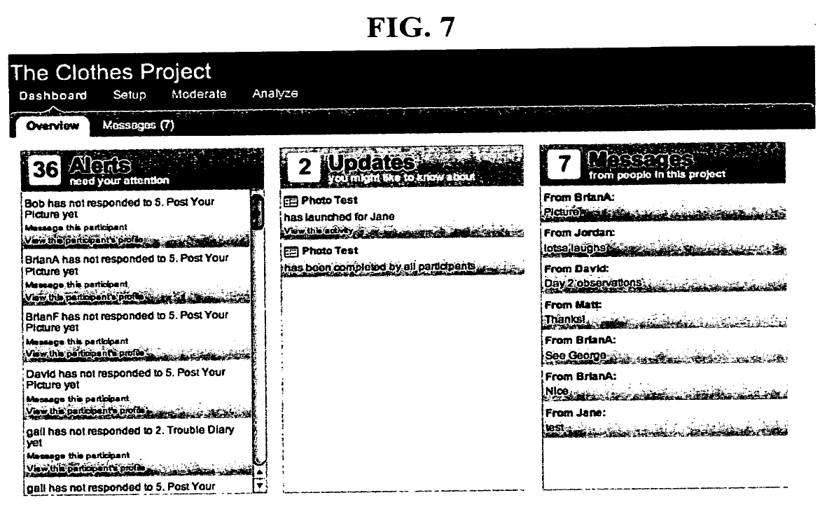

Referring to FIG. 7, the uppermost navigation bar also includes a “Dashboard” option wherein the researcher can quickly gain an at-a-glance view of matters that may require the researcher's attention. Under the “Dashboard” option on the uppermost navigation bar, the researcher may choose the tab “Overview”, under which are displayed “Alerts”, “Updates”, and “Messages”. These have the following significance.

(1) The “Alerts” section shown in FIG. 7 can indicate to a researcher whether any research participants have fallen behind in responding to activities/queries. For example, the “Alerts” can indicate whether participants have not fully responded to the queries of a given activity within the time period defined by the researcher. “Alerts” can also simply indicate whether one or more research participants have failed to access the research project at all, i.e., whether they are simply not participating. In these cases, the researcher is offered a link “Message this participant” by which the researcher can send a reminder to the research participant by email, instant message, (mobile) telephone call, or other means. This message could be provided instead of (or in addition to) any reminder message automatically sent by the system once the researcher's set feedback period for an activity has expired. Alternatively or additionally, a reminder can be posted on the website for the research project so that once the research participant logs in to access the research project, he/she might be given a notice that he/she is late to respond to one or more activities.

(2) Under the “Updates” section shown in FIG. 7, the researcher is advised of things that might be of interest but may not need immediate attention, such as research participants accessing the research project for the first time (e.g., by logging into the research project website); the launching of an activity (i.e., the activity being posted on the research project website to one or more segments for the first time); and/or activities closing (an activity reaching the scheduled deadline at which all research participants were to have their feedback submitted for the activity).

(3) The “Messages” section shown in FIG. 7 displays messages (e.g., emails) from research participants, and/or from research recruiters, clients/observers, etc.—for example, requests for help or explanation. When such messages are present, functionality is provided whereby the researcher can respond to such messages.

At any time during or after the research project, the researcher may review and analyze the collected feedback, and generate a report of summary observations and conclusions. This analysis and reporting functionality is illustrated in FIG. 8A-FIG. 10, and will now be discussed in greater detail.

FIG. 8A and FIG. 8B illustrate the researcher's choice of the “Analyze” option on the uppermost navigation bar, and of the “tags” tab beneath it. Selection of this option displays tag labels in the form of tag clouds (FIG. 8A) or a list (FIG. 8B), with the researcher choosing either option by use of the links near the right-hand side of the screenshots. In the tag clouds of FIG. 8A, the tag labels are listed, and the tag labels which are more frequently used in the research project's feedback are displayed with a larger font size. Thus, by viewing the relative size of tag labels within the tag cloud, a researcher can get a general idea of how prominent certain themes, facts, ideas, or other matter were within the collected feedback. Preferably, the researcher is allowed to view tag clouds for all segments and participants that were involved in the research project, as well as viewing tag clouds which are filtered by segments and/or participants. Thus, in FIG. 8A, the researcher is allowed to view a tag cloud generated for all research participants involved in the research project, as well as for a first and second segments (“Men” and “Women”). If the researcher clicks on one of the tag labels displayed in the tag cloud, the researcher will be provided with a list of all of the feedback entries tagged with the tag label (preferably with the accompanying queries that generated the feedback).

Alternatively, as illustrated in FIG. 8B, the researcher may view the tags as a simple list. Here, the list is presented as an alphabetically-ordered columnar list of tag labels, with the “Responses”, “Replies”, “Participants”, “Highlights”, and “Total” columns providing information on how many times a tag has been applied to research participant responses (i.e., a set of feedbackprovided in response to an activity), research participant replies to follow-up queries, research participants, highlights (as opposed to entire responses/replies), and also provides information regarding how many times a tag has been used in total.

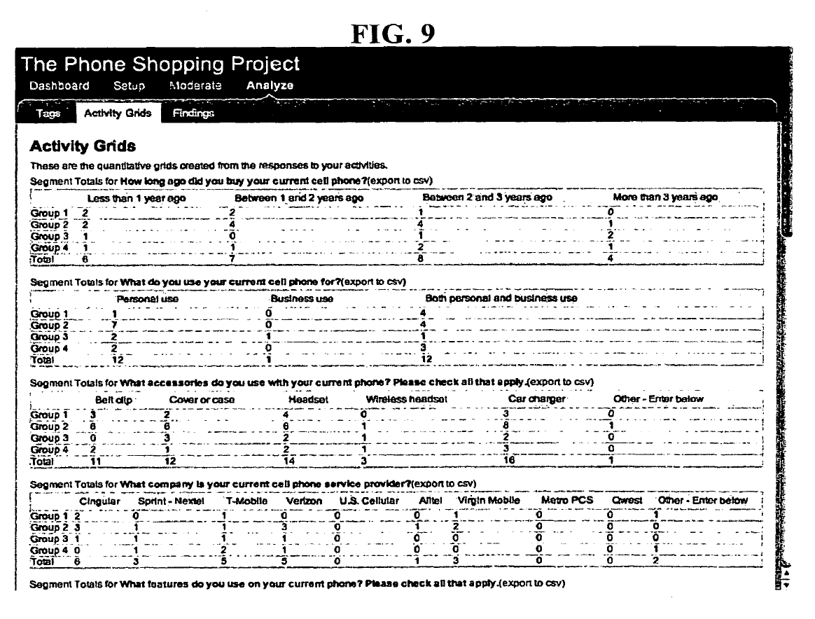

The researcher may also select the “Activity Grids” tab under the “Analyze” option on the uppermost navigation bar, and quantitative feedback will be graphically displayed to the researcher in tabular form for rapid comparison and analysis as illustrated in FIG. 9. Rather than having this screen present the quantitative feedback in the form of histograms, scattergrams, etc., it instead includes “export to CSV” links whereby the quantitative feedback displayed in reply to any given query may be exported as comma-separated values, which may in turn be easily imported into any number of commonly available data manipulation and graphing software packages. However, manipulation and graphing features can be incorporated directly into the research system if desired.

FIG. 10 then illustrates a qualitative data summary that may be prepared by a researcher by accessing the “Analyze” option from the uppermost navigation bar, and then selecting the “Findings” tab. Here, by reviewing feedback by activity/query and segment/participant (as in FIG. 6A-FIG. 6B), reviewing tags (as in FIG. 8A-FIG. 8B), or otherwise reviewing feedback, the researcher may isolate consumer desires, complaints, impressions, or other matter and simply summarize them in one or more sentences/paragraphs, and accompany these findings with one or more selected examples taken from the feedback. FIG. 10 illustrates an example of summary findings entered by a researcher under the heading “Sales pressure in carrier stores”, and which are provided with several items of feedback attached (these items being shown below the findings in abbreviated form, and being expandable to their full readable form when clicked). Similarly to the creation of activities in FIG. 3A, a researcher finding may be created by entering a desired name for the finding in the field near the right-hand side of the screen beneath the heading “Create New Set,” entering the finding in the “Notes” field near the left-hand side of the screen, using the “Download” link below to search for and access feedback entries supporting the finding, and then clicking “Save” beneath the “Notes” field. Ultimately, a researcher may present the client (the party commissioning the research project) with a report on the research project, in paper and/or electronic form, with collected findings, and with these collected findings including the “Notes” (conclusions and observations regarding research participant feedback) in association with any desired feedback and activity grids.

It is notable that the research system preferably allows several researchers to manage several research projects at the same time. Thus, it should be understood that the screen of FIG. 1, or prior/other screens, may allow researchers to access and switch between different research projects as desired. In the exemplary research system depicted in the drawings, when a researcher first logs into (accesses) the research system, he/she may choose a research project from a list of the preexisting research projects which he/she is authorized to conduct and/or view, or he/she may specify whether a new research project should be created. In either case, the researcher may thereafter navigate among the options shown on the uppermost navigation bar and the subobtions shown beneath, but where a new research project is created, the various fields shown in FIG. 1 (and in subsequent screens) will largely be empty, and awaiting the researcher's input.

When a researcher accesses the research system to generate a new research project (as in FIG. 1), it is also useful to give a researcher the ability to access previously-scripted research projects, and resave them with new project names (and without any associated research participant feedback that was collected). Researchers might then simply edit the prior research project to create a new research project. This can allow for extremely rapid creation of new research projects.

While not depicted in the foregoing screenshots, the screens depicted to the researcher in FIG. 1-FIG. 3A and FIG. 6A-FIG. 10 preferably also display (e.g., in the upper right-hand corner) an option whereby the researcher may exit the research project in question and access a list of any other research projects which the research system may be coordinating (or more specifically, any of these research projects which the researcher is authorized to view). The researcher can then enter any of these other research projects to view screens similar to the foregoing screens, and to access any of the functionality therein. The researcher may also be offered the option of logging out of the research system, and/or modifying the researcher's profile (e.g., researcher user name, password, email address, etc.).

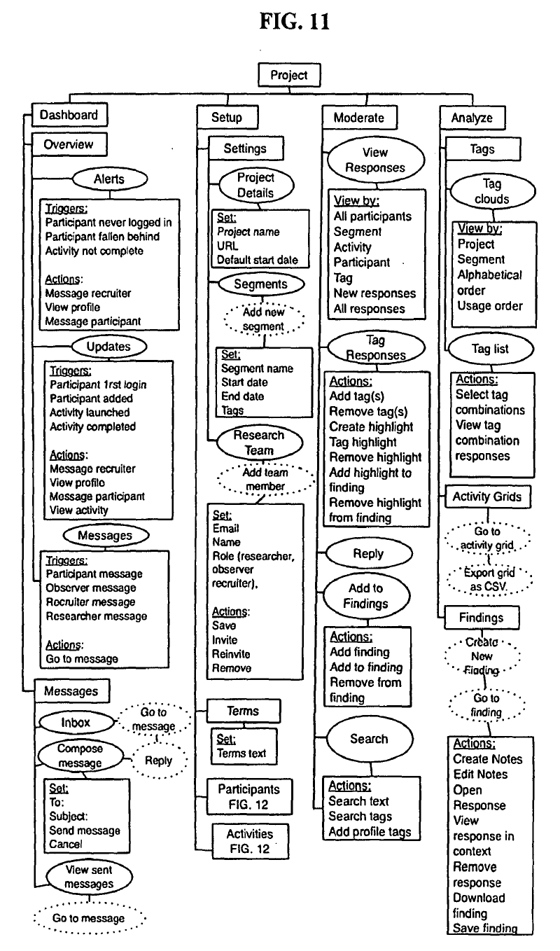

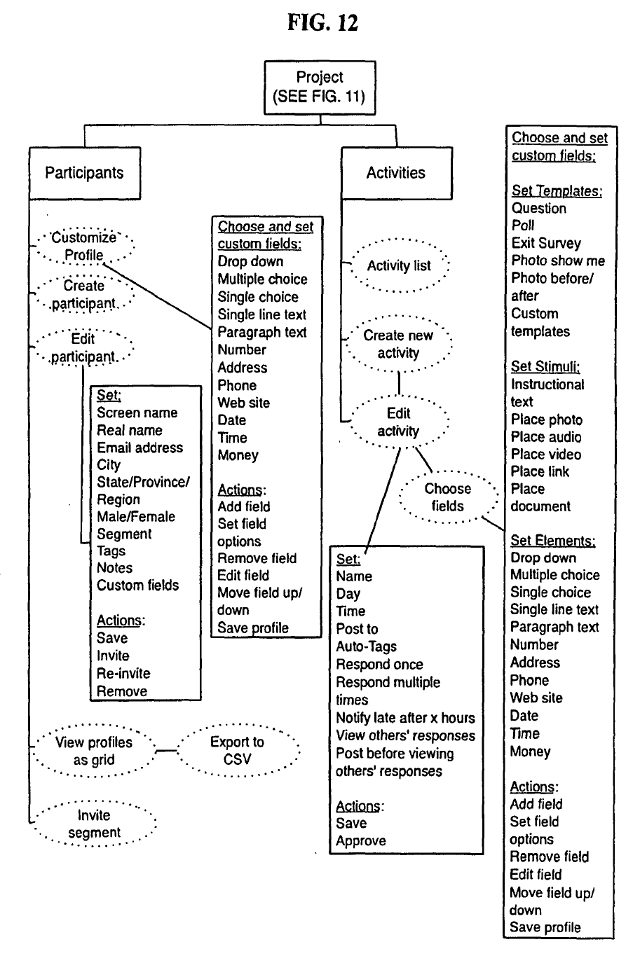

FIG. 11 then presents a summary of the previously-discussed options of the upper navigation bar, presented as a flowchart with each of the “Dashboard” options (FIG. 7), “Setup” options (FIG. 1-FIG. 3A), “Moderate” options (FIG. 6A-FIG. 6B), and “Analyze” options (FIG. 8A-FIG. 10) being situated in a respective vertical “column” of the chart, and with their various suboptions being listed beneath. It should be understood that owing to space issues, FIG. 11 may illustrate details/options which are not shown in the previously-discussed screenshots. Similarly, the screenshots may illustrate some details which are not listed in the chart of FIG. 11. FIG. 12 then presents certain subobtions available to the researcher under the “Setup” option, in particular, the “Participants” suboption (FIG. 2) and the “Activities” suboption (FIG. 3A-FIG. 3C), which are only generally represented in FIG. 11.

The foregoing discussion related primarily to an exemplary version of the research system as experienced by the researcher during the course of creating and conducting a research project. It is also useful to review the research system as experienced by a research participant. In the exemplary version of the research system discussed above, the research participant will usually access the research project by going to the website assigned to the project, and entering the research participant's assigned user name and/or password. The research participant may then be provided with a menu of options regarding:

(1) Settings, wherein the research participant might be able to change his/her user name and/or password, email address, or other such information.

(2) Activities, wherein the research participant might (a) access and provide feedback to any activity or activities for the research project(s) in which the research participant is involved (as exemplified in FIG. 5A, FIG. 5B, and FIG. 5C); (b) view any reminder regarding activities for which the research participant's feedback is overdue; and (c) compose a message to the researcher requesting explanation or help relating to the research project.

(3) Messages, wherein the research participant might be able to (a) compose a message to the researcher requesting explanation or help relating to the research project, and (b) receive messages from the researcher and/or research recruiters. Such messages could include, for example, messages regarding new research projects in which the research participant might be interested in participating; general messages or comments about a current activity or activities; general instructions for navigating the research system and providing feedback; and so forth. If a researcher sends a research participant follow-up queries (“probes”) in response to the research participant's feedback, the follow-up queries could appear here.

The exemplary research system described above enables researchers to collect, organize, and analyze research data—in particular qualitative research data—and report findings in an exceedingly rapid and efficient manner. This is accomplished in part by integrating the tasks of research participant selection, query scripting, query delivery, feedback collection, feedback review/analysis, and analysis report generation into a single system, and leveraging the efficiencies arising from their integration. Numerous modifications to the exemplary system can be made, and examples of selected modifications follow.

First, since the foregoing discussion relates to an exemplary system, it should be understood that the invention can be provided in software and similar applications which have an appearance substantially different from the one shown in the accompanying drawings/screenshots. Many of the features discussed above can be deleted or modified; additional features can be added; the “look and feel” and layout of the various features can be altered; and the features may be presented in different orders and/or with different flow (i.e., a researcher using a modified version of the exemplary system might access features in an order different from the one discussed above). It should therefore be kept in mind that the exemplary system is merely that—it is simply an illustration of a form that the invention might assume—but the invention is not limited to this form.

Second, the exemplary version of the research system depicted in the accompanying screenshots delivers queries to, and collects feedback from, research participants via a website constructed by the research system (with website parameters defined by the researcher in FIG. 1). While the Internet is a particularly convenient communications network over which the research system may be implemented, other forms of networked communication may be used, such as local area networks (“LANs”) and wireless communications networks, and the research system can be adapted to send queries and collect feedback by other modes of communication, such as via email, text messaging, voice delivery and recognition, and so forth. The ability to communicate with research participants via their mobile telephones and similar communications devices is valuable because this can allow query delivery and feedback collection while a consumer is actually engaging in real-world activities relating to the research project (e.g., while a consumer is actually shopping for a new mobile telephone).

Third, as feedback is collected from research participants, the research system may catalogue the words therein and generate a suggested list of tags/tag labels from which the researcher may draw and apply. As an example, the words/strings in the feedback could be compiled, sorted for frequency of occurrence, filtered for “stop words” (i.e., common words which convey little information about a topic, such as “the,” “of,” “and,” “to,” etc.), and stemmed (i.e., common morphological and inflectional endings can be removed, as by truncating the words, “running,” “runner,” etc. to “run”). The feedback can further be analyzed by the research system to identify words/strings which commonly occur adjacent to each other, and which might therefore be best treated as a single word (e.g., “mobile telephone”). Some number of terms from the resulting list could then be presented to the researcher (e.g., in the “Moderate” screens of FIGS. 6A and 6B) as terms which may be of interest for tagging in research participant feedback, either alone or in combination with adjacent words/strings. For example, for each research participant reply to an activity, the research system might cross-reference the terms in the research participant's feedback with the proposed list of terms which may be of interest for tagging, and “highlight” these terms. The researcher might then review the highlights, and confirm whether these terms (either alone or in combination with adjacent terms) should actually be tagged.

Fourth, with reference to FIG. 6A and FIG. 6B, which depict one way whereby a researcher can review feedback provided by research participants to a research participant (and provide follow-up queries and/or stimuli, if desired), it can also be useful to include a “Strike Response” option whereby a researcher may delete a research participant's feedback to a query, or to an entire activity. More specifically, in cases where research participants are allowed to view each others' feedback to a query or activity (as by use of options shown in the screenshot of FIG. 4), it can be useful to at least allow the researcher to select certain items of feedback and withhold them from review by other participants if the researcher finds it appropriate to do so. If certain submitted feedback is off-topic or inappropriate, it can then be withheld from viewing by other research participants. In this respect, it can also be useful to provide an option whereby the researcher reviews all submitted feedback and approves it before it is made available for viewing by other research participants.

Fifth, while the research system has been described in relation to its use in studying consumer behavior, it can be utilized for studies of other topics/fields instead. Examples include, without limitation, studies of employee satisfaction and workplace effectiveness; studies of patient states during treatment (e.g., during medical/psychological/psychiatric clinical trials); efficacy studies of educational/learning systems; and general academic (or commercial) studies of human thought and behavior relating to virtually any topic.

It should be understood that the versions of the invention described above are merely exemplary, and the invention is not intended to be limited to these versions. Rather, the scope of rights to the invention is limited only by the claims set out below, and the invention encompasses all different versions that fall literally or equivalently within the scope of these claims.

1. A method of conducting online research comprising the steps of:
a. securing research participants having desired participant characteristics;
b. providing the research participants with online queries seeking feedback from the research participants on one or more topics;
c. collecting the feedback online from the research participants, the feedback including one or more of text and images;
d. allowing a researcher to assign tags to the feedback from the research participants, each tag:
(1) being assigned to at least one of:
(a) a text string selected from text submitted by a research participant, and
(b) an image submitted by a research participant,
(2) having an associated tag label,
e. aggregating the text strings and images corresponding to each tag label.

2. The method of claim 1 wherein tags are assigned by a researcher to the feedback from the research participants by the researcher's:
a. running a cursor over the text string, or
b. placing a cursor atop the image,
which is to have a selected tag label assigned thereto.

3. The method of claim 2 wherein the text strings or images to which tags are assigned by a researcher are displayed to the researcher with a different appearance after the tags are assigned, whereby a researcher can visually determine which text strings or images have been tagged.

4. The method of claim 1 wherein both the tags and tag labels are not displayed to the research participants.

5. The method of claim 1 further comprising the step of visually displaying to the researcher at least some of the tag labels, wherein each of the displayed tag labels include a visually ascertainable indication of the number of text strings and images corresponding to the tag label.

6. The method of claim 5 wherein the displayed tag labels are displayed at a size proportionate to the number of text strings and images corresponding to the tag label.

7. The method of claim 5 further comprising the steps of:
a. allowing the researcher to select a tag label, and
b. upon selection of the tag label, displaying to the researcher at least some of the text strings or images corresponding to the tag label.

8. The method of claim 1 further comprising the steps of:
a. grouping the research participants into two or more researcher-defined segments, each segment including one or more research participants;
b. allowing the researcher to select one or more segments for display; and
c. displaying the feedback from the selected segments to the researcher.

9. The method of claim 1 wherein the step of providing the research participants with online queries includes the step of automatically periodically delivering online queries to each research participant, wherein each online query seeks feedback from the research participant on one or more topics.

10. The method of claim 9 further comprising the step of providing an alert to the researcher if a research participant does not provide online feedback to an online query within a predetermined time period.

11. The method of claim 9 further comprising the steps of:
a. collecting from the researcher at least some of the online queries to be periodically delivered to each research participant;
b. storing at least some of the online queries in association with a scheduled delivery time; and
c. subsequently automatically periodically delivering the online queries to each research participant at scheduled intervals in accordance with their scheduled delivery times.

12. The method of claim 11 further comprising the steps of visually displaying to the researcher:
a. the scheduled delivery times for each of the online queries, and
b. the online queries,
along a timeline.

13. The method of claim 12 wherein the feedback collected online from the research participants in response to the online queries is also visually displayed along the timeline.

14. The method of claim 12 wherein the timeline further includes a visual display of one or more of:
a. the number of research participants who have provided feedback to the online queries, and
b. the number of research participants who have not provided feedback to the online queries,
along the timeline.

15. The method of claim 12 further comprising the step of rescheduling the delivery of at least some of the online queries by moving at least some of the scheduled delivery times for the online queries along the timeline.

16. The method of step 9 further comprising the step of delivering a reminder to a research participant if the research participant does not provide online feedback to the online query within a predetermined time period.

17. The method of claim 1 further comprising the steps of:
a. visually displaying a timeline to the researcher;
b. collecting the online queries from the researcher;
c. displaying the online queries to the researcher along the displayed timeline in accordance with scheduled delivery times for each of the online queries;
d. delivering the online queries to the research participants in accordance with their scheduled delivery times;
e. displaying one or more of:
(1) the feedback collected from the research participants in response to the online queries,
(2) the number of research participants who have provided feedback to the online queries, and
(3) the number of research participants who have not provided feedback to the online queries,
to the researcher along the timeline.

18. The method of claim 17 further comprising the steps of:
a. grouping the research participants into two or more researcher-defined segments, each segment including one or more research participants; and
b. displaying, for each segment, one or more of:
(1) the online queries,
(2) the feedback collected from the research participants in response to the online queries,
(3) the number of research participants who have provided feedback to the online queries, and
(4) the number of research participants who have not provided feedback to the online queries,
to the researcher along the timeline.

19-20. (canceled)

21. A method of conducting online research comprising the steps of:
a. periodically delivering an online query to a research participant at scheduled intervals, wherein the online query solicits one or more of:
(1) quantitative feedback from the research participant on one or more topics, wherein the quantitative feedback consists of at least one of:
(a) data selected from a predefined set of discrete values presented to the research participant, and
(b) data selected from a continuous range of values presented to the research participant;
(2) qualitative feedback from the research participant on one or more topics, wherein the qualitative feedback consists of text freely entered by the research participant at the research participant's discretion;
b. collecting the quantitative feedback and qualitative feedback from the research participants;
c. assigning researcher-specified tags to the qualitative feedback wherein each tag:
(1) bears an associated tag label, and
(2) is assigned to a text string selected from the text within the qualitative feedback;
d. compiling within a database the tag labels and the text strings to which they are assigned; and
e. displaying at least a portion of the quantitative feedback in one or more of:
(1) tabular form,
(2) statistical form, and
(3) graphical form.

22. A method of conducting online research comprising the steps of:
a. collecting online queries from a researcher to be delivered to research participants, wherein each online query solicits feedback from the research participants;
b. storing each of the online queries in association with a respective scheduled delivery time;
c. automatically delivering the online queries to the research participants in accordance with their scheduled delivery times;
d. collecting the feedback online from the research participants, the feedback including text entered by the research participants;
e. visually displaying to the researcher along a timeline:
(1) the online queries,
(2) the feedback collected from the research participants in response to the online queries, and
(3) one or more of:
(a) the number of research participants who have provided feedback to the online queries, and
(b) the number of research participants who have not provided feedback to the online queries,
along the timeline.
